(19) United States
(12) Patent Application Publication
(10) Pub. No.: US 2016/0079820 A1
(43) Pub. Date: Mar. 17, 2016

(54) ROTATING ELECTRICAL MACHINE

(71) Applicant: TOSHIBA MITSUBISHI-ELECTRIC INDUSTRIAL SYSTEMS CORPORATION, Chuo-ku (JP)

(72) Inventors: Hirotake NAKAJI, Chuo-ku (JP); Yuichi TSUBOI, Chuo-ku (JP); Haruyuki KOMETANI, Chiyoda-ku (JP); Takuma SASAI, Chiyoda-ku (JP); Koji KISE, Chiyoda-ku (JP)

(73) Assignee: TOSHIBA MITSUBISHI-ELECTRIC INDUSTRIAL SYSTEMS CORPORATION, Chuo-ku (JP)

(21) Appl. No.: 14/780,415

(22) PCT Filed: Jan. 22, 2014
(86) PCT No.: PCT/JP14/00307

§ 371 Date: Sep. 25, 2015

(30) Foreign Application Priority Data
Mar. 27, 2013 (JP) 2013-066127

(51) Int. Cl. H02K 1/32; H02K 1/27

(52) U.S. Cl. CPC H02K 1/32; H02K 1/274

(57) ABSTRACT

A rotating electrical machine includes: a stator that includes a cylindrical inner hole; and a rotor that includes a rotation shaft being concentric with the inner hole of the stator and whose outer peripheral surface faces an inner peripheral surface of the inner hole across a predetermined gap, wherein a rotor core that is provided around the rotation shaft is divided into a plurality of portions in an axis direction thereof, and, inside each of rotor cores that are created by the division, a plurality of ventilation holes are formed around the rotation shaft in such a way as to pass therethrough in an axis direction thereof, and a spacer is provided between end surfaces of the rotor cores, and a duct is formed in such a way as to extend from the ventilation holes to the gap with the inner peripheral surface of the inner hole of the stator.

### TECHNICAL FIELD

Embodiments of the present invention relate to a rotating electrical machine having an improved ventilation structure of a rotor.

### BACKGROUND ART

As the ventilation structure of the rotor in the rotating electrical machine, such as an electrical motor or a power generator, there is one in which a rotor core is divided into a plurality of portions in an axis direction, and the space between end faces of the divided portions is used as a ventilation duct. However, in the case of a rotating electrical machine in which permanent magnets are mounted on the rotor, if the above-described ventilation duct is provided, the expensive permanent magnets are wastefully used.

That is, the permanent magnet is usually formed elongated. On an outer peripheral surface of the rotor or inside the core near the outer periphery, the permanent magnet is provided in such a way that the length direction thereof is aligned with an axis direction of the rotor. In this case, the permanent magnet partially overlaps the ventilation duct portion. Magnetic force from the permanent magnet is almost ineffective in the ventilation duct portion. This means that this part of the permanent magnet is wasted.

Since the permanent magnet is expensive as described above, the amount of permanent magnet to be used needs to be minimized. Therefore, providing the above-described air duct in the rotor is not a good idea. However, if no air duct is provided in the rotor, the air converges in a narrow gap with an internal peripheral surface of a stator core. As a result, a sufficient air flow rate cannot be achieved. Moreover, the air inside the above-described gap flows through air ducts that are provided in a plurality of axis-direction portions of the stator core in such a way as to extend in a radial direction. However, the air that flows through the gap comes out of a front duct. Therefore, the problem is that a central area of the stator is not sufficiently cooled.

As a ventilation cooling structure of the rotor with no ventilation duct, what has been proposed is a structure in which a ventilation hole is provided near a slot of the rotor core in such a way as to pass therethrough in an axis direction (Refer to Patent Document 1, for example).

As for the rotor on which a permanent magnet is provided, there has been an idea that a ventilation hole is provided in the rotor core in such a way as to pass therethrough in the axis direction and not to overlap with an area where the permanent magnet is provided, and an air hole is formed in the radial direction of the rotor core in such a way as to communicate with an outer peripheral surface of the rotor core from a length-direction middle portion of the ventilation hole.

### PRIOR ART DOCUMENT

### Patent Document

[Patent Document 1] Japanese Patent Application Laid-Open Publication No. 2003-319588

### SUMMARY OF THE INVENTION

### Problems to be Solved by the Invention

If the ventilation hole is provided in the rotor core in such a way as to pass therethrough in the axis direction thereof as described above and if the air hole is provided in such a way as to communicate with the outer peripheral surface of the rotor core from the length-direction middle portion of the ventilation hole, the air flows in to the ventilation hole of the rotor from both end portions thereof. Then, the air passes through the air hole from the middle portion and flows into the gap portion between the rotor and the stator. After that, the air comes out via the ventilation ducts that are provided in a plurality of axis-direction portions of the stator core in such a way as to extend in the radial direction. In this manner, the inside of the rotor core is cooled as the air flows.

However, in order to form the above-described ventilation route, in addition to ventilation holes that pass through the rotor core in the axis direction, an air hole needs to be formed for each of the ventilation holes in the axis-direction middle portion thereof. Usually, a plurality of ventilation holes are disposed around a rotation axis. Accordingly, air holes, which extend to the outer periphery surface of the rotor core, need to be formed in such a way that the number of the air holes is equal to the number of the ventilation holes. Accordingly, it requires many steps to make the rotor.

The air holes are provided in the axis-direction middle portion of the rotor core, resulting in a reduction in the cross-sectional area of this portion of the core. The problem is that an increase in magnetic flux density occurs in some parts.

The object of the present invention is to provide a rotating electrical machine that is able to effectively cool the inside of the rotor core through ventilation without causing the above problems and whose production does not require a large number of steps.

### BRIEF DESCRIPTION OF THE DRAWINGS

FIG. 1 is a diagram showing the basic configuration of a rotating electrical machine according to an embodiment of the present invention.

FIG. 2 is a diagram showing the shape of an end face of a rotating machine core of FIG. 1.

FIG. 3 is a plan view of a rotating machine core portion of FIG. 1.

FIG. 4 is a diagram showing another embodiment of the present invention.

### EMBODIMENTS FOR CARRYING OUT THE INVENTION

A rotating electrical machine according to an embodiment of the present invention is characterized by including: a stator that includes a cylindrical inner hole; and a rotor that includes a rotation shaft being concentric with the inner hole of the stator and whose outer peripheral surface faces an inner peripheral surface of the inner hole across a predetermined gap, wherein a rotor core that is provided around the rotation shaft is divided into a plurality of portions in an axis direction thereof, and, inside each of rotor cores that are created by the division, a plurality of ventilation holes are formed around the rotation shaft in such a way as to pass therethrough in an axis direction thereof, and a spacer is provided between end surfaces of the cores, and a duct is formed in such a way as to extend from the ventilation holes to the gap with the inner peripheral surface of the inner hole of the stator.

According to the above configuration, the inside of the rotor core can be effectively cooled through ventilation. Moreover, unlike the conventional case, processing of the air holes is not required. Therefore, it is possible to prevent an increase in magnetic flux density in some parts and to reduce the number of production steps.

Hereinafter, an embodiment of the present invention will be described in detail with reference to the accompanying drawings.

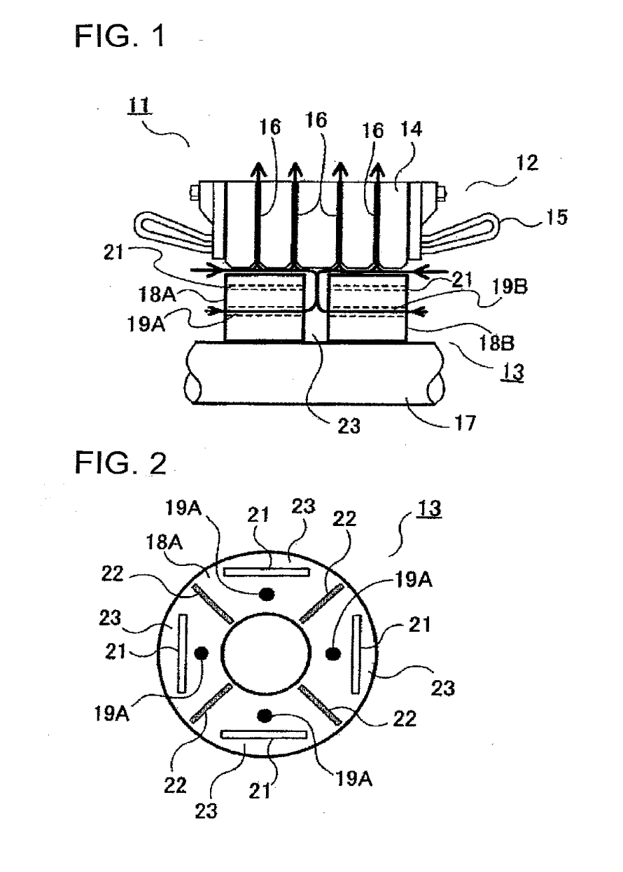

FIG. 1 is a diagram schematically showing an upper-half portion of the basic configuration of a rotating electrical machine 11, such as an electric motor or a power generator. In FIG. 1, the rotating electrical machine 11 includes a stator 12, which includes a cylindrical inner hole, and a rotor 13, which is provided in such a way as to be able to rotate inside the inner hole of the stator 12. The stator 12 includes a slot, not shown, which is an open groove on an inner peripheral surface (or lower surface as shown in the diagram) of a cylindrical stator core 14 (FIG. 1 shows only a cross section of an upper portion of the cylinder) and which extends along an axis direction. Inside the slot, a stator winding 15 is provided. In the stator core 12, ventilation ducts 16 are formed in a plurality of portions in the axis direction in such a way as to extend along a radial direction.

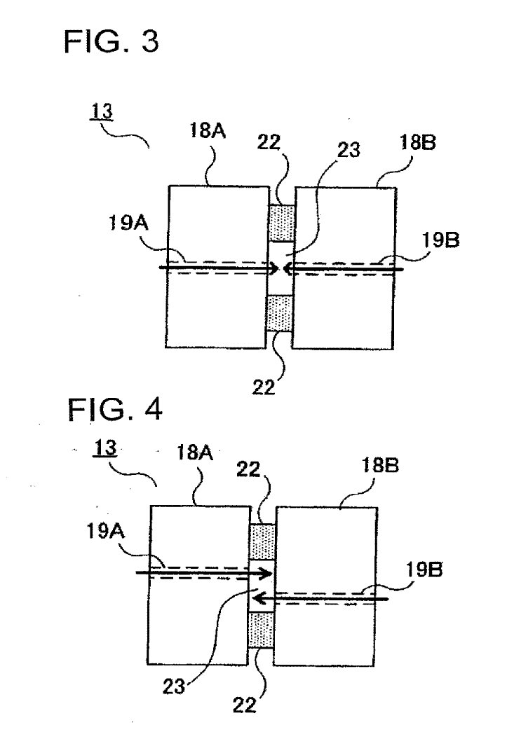

The rotor 13 includes a rotation shaft 17 that is concentric with the inner hole of the above-described stator 12. Around the rotation shaft 17, a rotor core 18 is integrally provided (FIG. 1 shows only a cross section of an upper portion). The rotor core 18 is in a columnar shape, and an outer peripheral surface thereof faces an inner peripheral surface of the inner hole of the stator 12 across a predetermined gap. As shown in FIGS. 1 and 3, the rotor core 18 is divided into a plurality of portions in an axis direction thereof (or into two portions in the case of the example shown in the diagram). In each of cores 18A and 18B, which are created by the division, a plurality of ventilation holes 19A and 19B are formed around the rotation shaft 17 in such a way as to pass therethrough in the axis direction thereof, as shown in FIG. 2.

The rotating electric machine 11 that is illustrated in the present embodiment has permanent magnets 21 in the rotor 13. However, the rotating electric machine 11 may not have permanent magnets. If the permanent magnets 21 are provided, the permanent magnets 21 are integrally embedded in the rotating machine cores 18A and 18B in such a way as to be close to the outer peripheral surfaces, as shown in FIG. 2. The permanent magnets 21 have rectangular end faces shown in FIG. 2, and are embedded across the entire length of the rotating machine cores 18A and 18B in the axis direction.

Between the end faces of the rotating machine cores 18A and 18B that face each other as shown in FIG. 3, spacers 22 are provided. As shown in FIG. 2, the spacers 22 are radially disposed for each of a plurality of ventilation holes 19A (four ventilation holes, in the example shown in the diagram) that are opened at the end surface of the rotating machine core (which is described as 18A, while the core 18B has the same configuration) in such a way as to define end-face regions in which the ventilation holes 19 are located. Space set by the spacers 22 functions as a duct 23, which guides the air from a corresponding ventilation hole 19A in the radial direction into the gap with the internal peripheral surface of the stator core 14.

If the permanent magnets 21 are provided, as shown in FIG. 1, the permanent magnets 21 are provided for each of the rotating machine cores 18A and 18B. There is no permanent magnet in the duct 23, which is formed between the rotating machine cores 18A and 18B.

According to the above-described configuration, the rotating electrical machine 11 starts to run, and the rotor 13 rotates inside the inner hole of the stator core 14. Ambient air flows into the narrow gap between the inner peripheral surface of the stator core 14 and the outer peripheral surface of the rotor core 18. Then, as indicated by arrow in the diagram, the air travels through the ventilation ducts 16, which are provided in a plurality of portions of the stator core 14 in the axis direction in such a way as to extend in the radial direction, before coming out of the core. Moreover, in the rotor cores 18A and 18B, the ventilation holes 19A and 19B are provided in such a way as to pass therethrough in the axis direction thereof. Accordingly, the ambient air flows into the ventilation holes 19A and 19B as well.

As described above, the space between the rotor cores 18A and 18B, which are created by the division, functions as duct 23. The air that flows through the ventilation holes 19A and 19B flows into the duct 23, which is located at a middle point therebetween, as indicated by arrow in FIGS. 1 and 3. The duct 23 communicates with the outer periphery of the rotor core. Accordingly, as indicated by arrow in FIG. 1, the air flows into the gap with the inner peripheral surface of the stator core 14, and the flows out via the ventilation ducts 16 that are provided in a plurality of portions in the axis direction of the stator core 14 in such a way as to extend along the radial direction.

In that manner, in the rotor cores 18A and 18B, the ventilation holes 19A and 19B are provided in such a way as to pass therethrough in the axis direction thereof. Moreover, between the rotor cores 18A and 18B, the duct 23 is provided. Therefore, in the rotor 13, the air flows into the ventilation holes 19A and 19B from both end portions thereof. Then, the air travels through the duct 23, which is located between the rotor cores 18A and 18B, before flowing into the gap portion between the rotor 13 and the stator 12. Furthermore, the air flows out of the core via the ventilation ducts 16 provided in the stator core 14. In this manner, the inside of the rotor cores 18A and 18B can be effectively cooled as the air flows therethrough.

According to the above configuration, the space between the rotor cores 18A and 18B, which are created by the division, is used as the duct 23. Therefore, unlike the conventional case, there is no need to provide a plurality of air holes in the central portion of the rotor core. Thus, it is possible to reduce the number of steps to form the air holes, resulting in a significant drop in the number of production steps. Moreover, a partial increase in magnetic flux density associated with drilling of a plurality of air holes in the central portion of the rotor core does not occur. Even if permanent magnets are provided in the rotor core as in a permanent magnet-type synchronous motor, the expensive permanent magnets 21 would be provided only in the rotating machine cores 18A and 18B as shown in FIG. 1. Accordingly, unlike the conventional case, parts of the permanent magnets do not overlap with the ventilation duct portions. In this manner, the amount of permanent magnet to be used can be minimized, and waste is eliminated.

Below is an explanation of an embodiment shown in FIG. 4. According to this embodiment, the rotor cores 18A and 18B, which are created by the division, are disposed in such a way that the ventilation holes 19A and 19B, which pass through the rotor cores 18A and 18B in the axis direction, are separated by a predetermined distance (or skewed) in a circumferential direction around the rotation shaft 17.

In the case of the embodiment shown in FIG. 3, in the central duct 23, the air coming out of the ventilation hole 19A and the air coming out of the ventilation hole 19B on the other side interfere with each other. Therefore, the length of the duct (or the distance between the end faces shown in the diagram) needs to be made long. However, according to the configuration of this embodiment, the rotor cores 18A and 18B are skewed. Therefore, in the central duct 23, there is no interference between the air coming out of the left ventilation hole 19A and the air coming out of the right ventilation hole 19B. Therefore, the length of the duct can be shorter compared with the configuration of FIG. 3. If the permanent magnets 21 are provided in the rotor cores 18A and 18B, a reduction in cogging torque, which is an original objective of skewing, can be achieved as the permanent magnets 21 of the rotating machine cores 18A and 18B are located apart from each other. As a result, while keeping the amount of permanent magnet to be used as low as possible, it is possible to achieve an improvement in cooling efficiency and reduce the cogging torque.

While certain embodiments of the present invention have been described, these embodiments have been presented by way of example only, and are not intended to limit the scope of the invention. The novel embodiments may be embodied in a variety of other forms; various omissions, substitutions and changes may be made without departing from the spirit of the invention. The accompanying claims and their equivalents are intended to cover such forms or modifications as would fall within the scope and spirit of the invention.

1. A rotating electrical machine comprising:
a stator that includes a cylindrical inner hole; and a rotor that includes a rotation shaft being concentric with the inner hole of the stator and whose outer peripheral surface faces an inner peripheral surface of the inner hole across a predetermined gap, wherein
a rotor core that is provided around the rotation shaft is divided into a plurality of portions in an axis direction thereof,
inside each of rotor cores that are created by the division, a plurality of ventilation holes are formed around the rotation shaft in such a way as to pass therethrough in an axis direction thereof, and
a spacer is provided between end surfaces of the cores, and a duct is formed in such a way as to extend from the ventilation holes to the gap with the inner peripheral surface of the inner hole of the stator.

2. The rotating electrical machine according to claim 1, wherein
the cores created by the division are disposed in such a way that the ventilation holes, which pass through the cores in the axis direction, are separated by a predetermined distance in a circumferential direction around the rotation shaft.

3. The rotating electrical machine according to claim 1, wherein
in the cores created by the division, permanent magnets are placed along the axis direction, and, between the cores, the permanent magnets are separated by a predetermined distance in a circumferential direction around the rotation shaft.

4. The rotating electrical machine according to claim 2, wherein
in the cores created by the division, permanent magnets are placed along the axis direction, and, between the cores, the permanent magnets are separated by a predetermined distance in a circumferential direction around the rotation shaft.
